(19) United States
(12) Patent Application Publication
(10) Pub. No.: US 2003/0144786 A1
(43) Pub. Date: Jul. 31, 2003

(54) System and method for monitoring the traction of a motor vehicle

(76) Inventors: Ulrich Hessmert, Schwieberdingen (DE); Jost Brachert, Ditzingen (DE); Thomas Sauter, Remseck (DE); Helmut Wandel, Markgoeningen (DE); Norbert Polzin, Zaberfeld (DE)

Correspondence Address: KENYON & KENYON, ONE BROADWAY, NEW YORK, NY, 10004, US

(21) Appl. No.: 10/220,388

(22) PCT Filed: Dec. 20, 2001
(86) PCT No.: PCT/DE01/04847

(30) Foreign Application Priority Data
Dec. 30, 2000 (DE) 100 65 764.8

(51) Int. Cl. B60T 8/00; G01L 5/13

(52) U.S. Cl. 701/82; 701/83; 701/78; 701/80; 73/9; 73/862.041

(57) ABSTRACT

The present invention relates to a system for monitoring the traction of a motor vehicle having at least two wheels (12) that includes at least one wheel-force sensor (10) which is assigned to a wheel (12), detects at least one wheel-force component of the respective wheel (12) acting essentially between the road surface and tire contact surface, emits a signal (Si, Sa) representing the wheel-force component, and includes an evaluation device (14) that processes the signal (Si, Sa) representing the wheel-force component of the wheel (12). According to the invention, the evaluation device (14) evaluates when the relevant wheel (12) is lifting off according to the processing results. The invention furthermore relates to a method for monitoring traction.

The present invention relates to a system for monitoring the traction of a motor vehicle having at least two wheels, the system including at least one wheel-force sensor which is assigned to a wheel and which detects at least one wheel-force component of the wheel in question that essentially acts between the road surface and tire contact area and which emits a signal representing the wheel-force component, and the system also including an evaluation device that processes the signal representing the wheel-force component of the wheel.

In addition, the present invention relates to a method for monitoring the traction of a motor vehicle of this type, preferably to be implemented via a system according to the invention, having the following steps: detection of at least one wheel-force component acting essentially between the road surface and tire contact surface on at least one wheel, and processing of the detected wheel-force component.

### BACKGROUND INFORMATION

The system and method of the species are used for driving dynamics controllers and regulators. For example, they are used as a partial system or partial method in conjunction with antilock braking systems (ABS), traction control systems (TCS) and the electronic stability program (ESP). It is known to detect the speed of the individual vehicle wheels or the transverse acceleration of the vehicle via sensors, and to use the quantities detected in this manner to control and/or regulate vehicle handling. Although, good results are already being achieved using the known methods and systems, an interest exists, especially in view of traffic safety, to further improve the known method and systems.

Within the context of the mentioned control systems, it is also known to draw conclusions about the traction of the motor vehicle by evaluating certain measured quantities. For this purpose, numerous quantities are currently being measured directly or indirectly, such as wheel speeds, vehicle speed, engine drive torque, wheel acceleration and wheel slip. The traction state of the vehicle is then determined by processing these quantities using a processing module, and, in some cases, the operating state of the vehicle is altered by intervening in the engine and/or brakes to improve vehicle traction.

Increasingly higher demands are being placed on the mentioned control systems (ABS, TCS, ESP), for example, to regulate the handling of a motor vehicle in off-road driving. Detecting, for example, wheels that have lifted off from the road diagonally or only one wheel that has lifted off on one side is of crucial significance for off-road vehicles in off-road driving.

In conjunction with sensors of the species, it is further known that different tiremakers plan to use so-called “intelligent” tires. This means that new sensors and evaluation circuits may be mounted directly on the tire. The use of tires of this type permits additional functions, such as measuring torque that occurs on the tire transversally and longitudinally in relation to the direction of travel, the tire pressure, or the tire temperature. In this regard, each tire may, for example, have magnetized areas or strips with field lines that are preferably incorporated circumferentially. The magnetization, for example, is always accomplished within each section in the same direction, but with opposing orientation, that is, with alternating polarity. The magnetic strips preferably run near the rim flange and tire-contact area. The sensors therefore rotate at the same speed as the wheel. Corresponding sensors are preferably mounted permanently on the body at two or more different points in the direction of rotation, and their radial distance from the axis of rotation differs. As a result, an inner measuring signal and an outer measuring signal may be maintained. It is then possible to detect the rotation of the tire via the changing polarity of the measuring signal(s) in the circumferential direction. The wheel speed, for example, may be calculated from the rolling circumference and the change over time in the inner measuring signal and the outer measuring signal.

It has also already been suggested to place sensors in the wheel bearing, this arrangement being possible in both the rotating and the static parts of the wheel bearing. For example, the sensors may be microsensors in the form of microswitch arrays. Force and acceleration, as well as the speed of a wheel, to name a few examples, are measured by the sensors mounted on the movable part of the wheel bearing. These data are compared to electronically stored basic patterns or to data of an equivalent or similar microsensor that is mounted on the stationary part of the wheel bearing.

### ADVANTAGES OF THE INVENTION

The present invention builds on the system mentioned at the outset in that the evaluation device evaluates the liftoff behavior of the respective wheel depending on the processing results. The liftoff behavior of a wheel of the motor vehicle is thus determined directly from the signal emitted by the wheel-force sensor. This essentially yields two advantages. First of all, in contrast to related-art systems in which numerous different sensors are needed, the liftoff behavior of a sensed wheel may be reliably monitored using a single sensor.

Secondly, by determining a wheel-force component, the liftoff tendency of a monitored wheel may also be determined when the vehicle is at a standstill, whereas systems of the related art rely on vehicle dynamics variables to determine lifting, and this requires the motor vehicle to be moving.

When it states below that a force or a force component is measured via a sensor, this includes not just the direct measurement of the force (component), itself, but also of course the measurement of a variable proportional to this force (component), as is conventional in sensor technology. An example of such a force-proportional variable can be a deformation.

Any kind of signal may be used for the signal representing the wheel-force component. However, to make it easier to process the signal, it is preferable to use an electrical signal.

In a simple case, the evaluation device may evaluate the liftoff behavior of the wheel in question with very little effort by comparing the signal representing the wheel-force component to at least one predetermined wheel-force-threshold and evaluate the liftoff behavior of the relevant wheel according to the comparative result.

In addition to or as an alternative to comparing the detected wheel-force component to a predetermined wheel-force-threshold, the same wheel-force components may also be detected on at least two wheels, preferably on all wheels, and compared to each other. For this advantageous embodiment, it is necessary for at least one sensor to be assigned to each of a corresponding number of wheels. A greater number of sensors can increase the precision of the evaluation results and, enables difficult-to-detect disturbances, such as road surface irregularities and the like, to be implicitly considered or filtered out when comparing wheel-force components to each other.

In principle, the system according to the present invention, as well as the method according to the invention that is described below, exploit the fact that forces acting between wheels of a vehicle and the road surface change, at least in quantitative terms, when a wheel lifts off. For example, a wheel contact force, which is a wheel-force component acting orthogonally to the tire contact surface, experiences a clear change. Therefore, the sensor may be a wheel-contact-force sensor that detects wheel contact force. This enables the control and/or regulation interventions to be made easily and hence quickly in the operation of the vehicle.

Alternatively or additionally, a lateral wheel force sensor may be used as a sensor that detects the lateral wheel force acting orthogonally to the wheel contact force. When the wheel contact force changes, the lateral wheel force in particular also changes. The liftoff tendency of a vehicle can be evaluated with great precision using lateral wheel force if the lateral wheel force is detected on several wheels, preferably on all wheels, of the vehicle, and the measured lateral wheel forces are compared to one another.

A further problem which may occur especially in vehicles having a high center of gravity and a short wheelbase, is that they tip during abrupt changes in speed or when cornering. If, for example, S-shaped cornering, i.e., cornering in alternating curve directions, is done at specific speeds and with a suitable alternating rhythm, then the wheel forces may build up from curve to curve until the vehicle finally rolls over about a horizontal axis running in the direction of travel. Vehicles having low centers of gravity can also be caused to roll over when driven in this manner.

Since a vehicle tips, not just due to the momentary wheel-force component, but more precisely due to its change over time, the danger of this type of tipping may be estimated using an advantageous development of the system according to the present invention: the system has a memory module for storing a preceding sensor signal, and then the evaluation device determines a change in the detected wheel-force component over time by processing the preceding sensor signal and an active signal, comparing it to a predetermined change-threshold, and evaluating the liftoff behavior of at least the one wheel based on the comparative results. However, note that a less accurate estimation is already possible using the wheel forces alone.

Whether the vehicle is threatening to tip, and if so the axis it will tip on, may be determined by the evaluation device more accurately by identifying the wheels that experience too great a reduction in wheel force over time and/or a wheel-force-threshold is undershot. If wheels that satisfy at least one of these conditions are on the same side of the vehicle, i.e., front, rear, left or right, then the vehicle may tip over with these wheels as the tipping point. The possible tipping axis is then the connecting line running between the tire contact points of these wheels.

Beyond detecting the liftoff behavior of one or more tires, traffic safety may be further increased if the evaluation device emits an actuating signal based on the evaluation result, and if the system includes an actuator that affects the operating state of the motor vehicle according to the actuating signal.

The actuating device can thereby suitably influence the operating state of the vehicle and, thus, increase the traction of one or all of the vehicle tires.

A change in the engine output and/or wheel brake pressure of at least one wheel of the motor vehicle, to name two examples, are possible interventions in the operating state of the motor vehicle. According to one feature of the present invention, the engine output may be influenced by adjusting the ignition timing, and/or by changing the throttle valve setting, and/or via targeted injection blank-outs.

To make more specific actuator adjustments to influence the vehicle operating state, it is especially advantageous if the system according to the present invention includes a speed sensor, and if the vehicle speed is included in the evaluation of the liftoff and/or in the determination of the actuating signal.

Different actuator adjustments in the operating behavior of the motor vehicle are conceivable depending on the number of wheels monitored by the sensor and the detected driving situation. In the following, a non-definitive listing of examples is given of how the operating state may be affected of a motor vehicle using the system or the method according to the present invention (explained in greater detail below).

The vehicle may be prevented from tipping about a tilt axis running in the direction of travel, e.g., by increasing the wheel brake pressure of a wheel on the outside of a curve (preferably all wheels on the outside of a curve) to generate yawing moment to stabilize the vehicle position.

A passenger vehicle having four wheels on the front axle or the rear axle may be prevented from tipping due to excessive braking about an axis disposed orthogonally to the direction of travel and parallel to the road surface, by reducing the wheel braking pressure on the wheels functioning as tipping points via the actuating device.

By detecting wheel contact force on several wheels, preferably on all wheels of a motor vehicle, and by comparing them to each other, wheels that are lifting off and/or a strong reduction of wheel load can effectively be determined. The detected traction state can be evaluated as a function of driving speed while starting, that is, starting from a standstill, as well as for normal driving, that is, at a driving speed less than 80 km/h, and be further processed in a TCS algorithm as follows:

While starting, the braking torque regulation to regulate center differential locking (regulation of the locking of the center-differential of a motor vehicle) and to regulate axle-differential locking (regulation of differential-gear locking) may be controlled with greater sensitivity.

Outside of the starting period, the sensitivity of the brake torque regulation can be reduced to maintain a robust regulation in reaction to road surface irregularities, such as potholes, bumps and the like. The same is true for engine torque regulation.

Moreover, this allows protection against stalling adapted to off-road driving, that is, a high starting torque is ensured.

An interruption in traction or the digging in of individual wheels may be reduced by minimizing the differential slip in the context of the axle differential lock regulation.

Simultaneously, pilot control measures can be developed for wheels (for example, the front or rear wheels, or on diagonally opposite wheels), and braking pressure can be applied to the wheels exhibiting little contact force. In this way, force can be transmitted to the wheels having greater contact force during the starting operation.

These achievements of the present invention are of particular significance for off-road vehicles. Due to irregularities in the terrain, individual wheels are frequently not in contact with the road surface. A situation of this type may be detected even at a standstill, that is without prior wheel movement, and the lifted wheels or the wheels with the least wheel contact force can be prevented from turning by a constant supply of wheel braking pressure, and force is transmitted in each case to the other wheels.

If an increase in the contact force of individual wheels is detected by the sensor(s), the braking pressure may be gradually diminished on the wheels previously exhibiting a low contact force which allows these wheels, in accordance with their contact force, to also transmit their drive torque to the roadway.

The present invention may be very effective in conjunction with devices for controlling and/or regulating the handling of motor vehicles, such as an anti-lock braking system and/or a TCS and/or an ESP system. In order to keep the number of system components as low as possible, the actuating device and, in some cases, the evaluation device may be part of such a device.

In order to improve TCS algorithms for regulating differential locks, it is very advantageous to precisely monitor wheels that are lifting off or wheels having a greatly reduced load. In this way, specific off-road measures for situations that normally do not occur on conventional streets may be activated in the algorithms. This type of detection improves the performance of the TCS and differential lock controller and simultaneously prevents erroneous activation of off-road measures on other roadways.

Since the detected wheel-force component is a force component acting between the road surface and the tire contact surface, it is advantageous for the measurement of the wheel-force component to be highly precise in this instance as well, for example, via an initially-described tire sensor. Wheel bearing sensors of the type described at the outset may also be used in place of or in addition to tire sensors. The wheel bearing sensors are very robust and are also located close to the site of action of the force to be detected. Both sensor types have the additional advantage that they are able to detect wheel contact force, lateral tire force, and, beyond that, wheel speed.

The cited advantages and effects may also be achieved using a system for controlling and/or regulating the handling of a motor vehicle having at least one tire and/or a wheel. A force sensor is located in the tire and/or on the wheel, especially on the wheel bearing, and a wheel variable that represents the tendency of the wheel to lift off from the roadway is determined as a function of the output signals of the force sensor, and the wheel variable is used for the control and/or regulation of the handling.

The present invention builds on the initially-cited method in that the processing step includes the evaluation of the liftoff tendency of the respective wheel based on the detected wheel-force component. The above-described advantages of the system according to the invention are likewise obtained from the method according to the present invention. Therefore, the above system description should be consulted for an explanation to clarify the method.

Thus, little computational outlay is needed to compare the detected wheel-force component to at least one predetermined wheel-force threshold value. The liftoff tendency may then be evaluated based on the results of the comparison.

Alternatively or additionally, a wheel-force component of at least two vehicle wheels may be detected to increase the evaluation precision. This allows the advantageous possibility of comparing the detected wheel-force components of at least two wheels and of thereby filtering out any disturbances caused by the condition of the roadway surface.

The wheel contact force of the relevant wheel and/or the lateral wheel force of the relevant wheel may be detected as the wheel-force component.

A determination of the change over time in the detected wheel-force component and its comparison to a predetermined change threshold help promptly identify that a vehicle is turning over.

Moreover, an operating state of the motor vehicle may be influenced according to the evaluation result to eliminate critical driving or operating states. Such an influence can be a change in the engine output and/or a change in a wheel brake pressure of at least one wheel. Should the influence occur in the form of increased wheel brake pressure for at least one wheel while cornering, it may be advantageous for this increase to occur on the wheel toward the outside of the curve to exert stabilizing yawing moment on the vehicle.

The measures to influence the vehicle operating state may be precisely differentiated by including the vehicle speed in the evaluation step. Since the vehicle speed plays a large role in vehicle dynamics, knowledge of the speed allows the most appropriate influences to be selected in each case.

Little engineering is required to precisely influence the vehicle's operating state with a device for controlling and/or regulating the handling of a motor vehicle, such as an anti-lock braking system and/or a TCS system. Such devices are already available as complete systems that were designed specifically to modify the operating state of vehicles.

### DRAWINGS

The present invention is explained in detail below with reference to the accompanying drawings.

The figures show:

FIG. 1 a block diagram of a system according to the present invention;

FIG. 2 a flow chart of a method according to the present invention;

FIG. 3 a section of a tire equipped with a tire sidewall sensor; and

FIG. 4 exemplary signal curves of the tire sidewall sensor depicted in FIG. 3.

### DESCRIPTION OF THE EXEMPLARY EMBODIMENTS

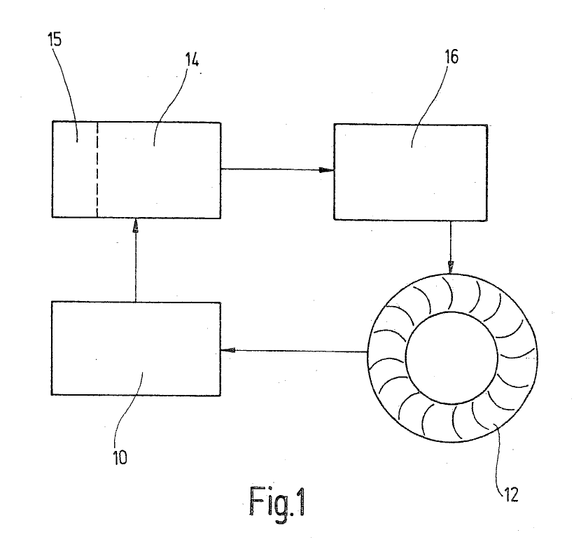

FIG. 1 shows a block diagram of a system according to the present invention. A sensor 10 is assigned to a wheel 12, depicted wheel 12 representing the wheels of a vehicle. Sensor 10 is connected to evaluation device 14 for processing signals of sensor 10. Evaluation device 14 includes memory module 15 for storing detected values. Evaluation device 14 is, in addition, connected to actuating device 16. This actuating device 16 is, in turn, assigned to wheel 12.

In the example shown here, sensor 10 detects the contact force of wheel 12. In the same way, sensor 10 could detect the lateral force of wheel 12. The detection results are communicated to evaluation device 14 for further processing. For example, the wheel contact force is determined in evaluation device 14 from a detected deformation of the tire. This can be accomplished by using a characteristic stored in memory module 15. In evaluation device 14, the liftoff tendency of the monitored wheel may furthermore be determined from the wheel contact force. This signal may be transmitted to actuating device 16 so that influence can be exerted on the operating state of the vehicle, especially on wheel 12, as a function of the signal. The influence can occur as described above, for example, by influencing the engine and/or a brake.

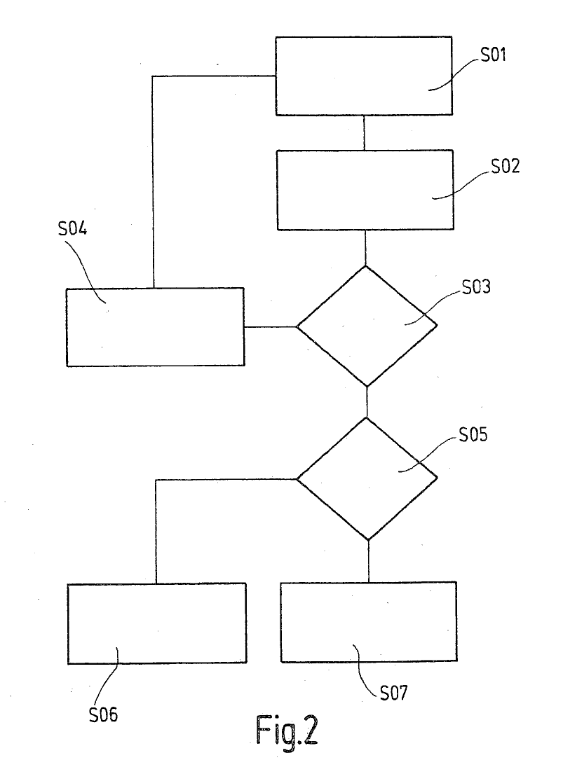

FIG. 2 shows a flow diagram of one embodiment of the method according to the present invention that depicts an evaluation of the liftoff behavior of a monitored wheel. The system shown in FIG. 1 is particularly suited to carry out the method of the present invention.

The significance of the individual steps is indicated below:

S01: Detection of a deformation in the radial or circumferential direction of a tire.

S02: Calculation of the contact force of the tire on the road surface from the detected deformation.

S03: Comparison of the determined contact force of the tire with a first predetermined contact force threshold.

S04: Detection of a normal driving condition.

S05: Comparison of the determined contact force of the tire to a second predetermined contact-force threshold value.

S06: Detection of critical reduction in wheel load.

S07: Recognition that the wheel has lifted off.

The procedural steps shown in FIG. 2 can be followed in the same or a similar manner for a rear-wheel drive or even a front-wheel drive vehicle.

In Step S01, a tire deformation is measured in the radial direction.

A wheel contact force is determined from the deformation in step S02. This is done with reference to a characteristic curve stored in a memory module that indicates the relationship between the radial deformation and the wheel contact force.

In step S03, the measured wheel contact force is compared to a predetermined contact-force threshold value. If the first contact-force threshold is not undershot, then, in step S04, a normal driving state is detected. If, on the other hand, the predetermined first contact-force threshold is undershot, then, in step S05, the determined wheel contact force is compared to a predetermined second contact-force threshold.

If the predetermined second contact-force threshold is not undershot, a “critical wheel-load loss” is detected in step S06. If, on the other hand, the predetermined second contact-force threshold is also undershot, a “critical wheel-load loss” state is detected in step S07.

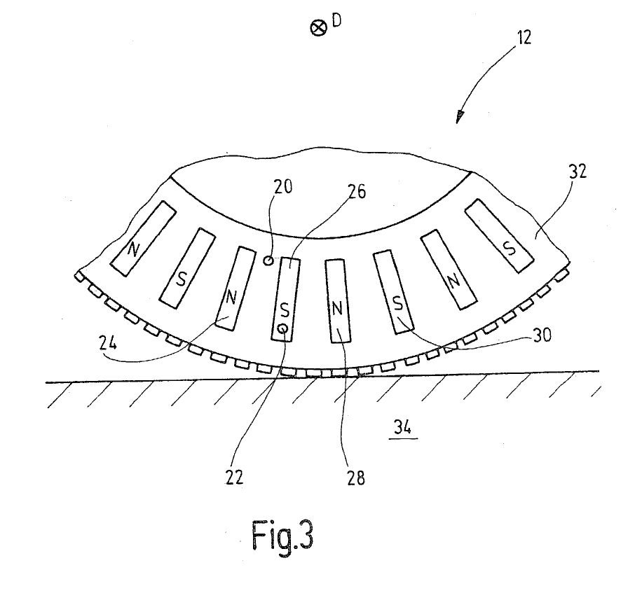

In FIG. 3, a section from a tire 32 that is mounted on wheel 12 is depicted with a so-called tire/sidewall sensor 20, 22, 24, 26, 28, 30 viewed in the direction of axis of rotation A of tire 32. Tire/sidewall sensor 20 includes two sensors 20, 22 that are permanently mounted on the vehicle body at two different points along the direction of rotation. Furthermore, sensors 20, 22 each have a different radial distance from the axis of rotation of wheel 32. The sidewall of tire 32 is provided with a multiplicity of magnetized areas functioning as measured-value transmitters 24, 26, 28, 30 (strips) running essentially in a radial direction with respect to the wheel's axis of rotation and preferably having field lines running in a circumferential direction. The magnetized areas have alternating magnetic polarity.

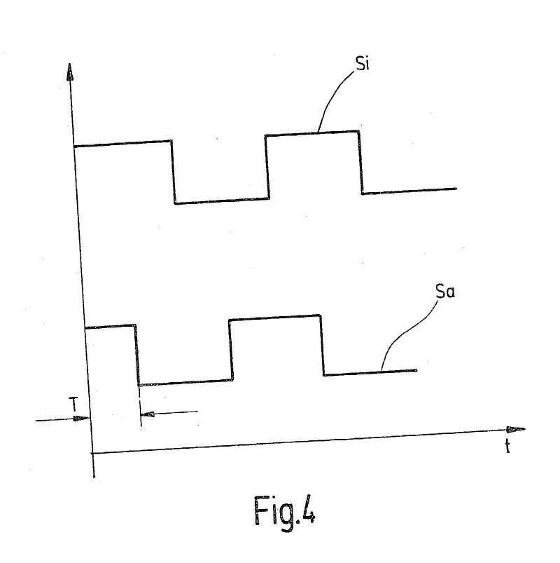

FIG. 4 shows the curves of signal Si of sensor 20 from FIG. 3 located toward the inside, that is, closer to axis of rotation A of wheel 12, and of signal Sa of sensor 22 from FIG. 3, which is toward the outside, that is, further away from the axis of rotation of wheel 12. A rotation of wheel 32 is detected via the alternating polarity of measuring signals Si and Sa. The wheel speed, for example, may be calculated from the rolling circumference and the change over time of signals Si and Sa. The torsion of wheel 32 may be determined via phase shifts between the signals allowing e.g. wheel forces to be measured directly. Within the context of the present invention, it is particularly advantageous to determine the contact force of wheel 32 on road 34 in FIG. 3, since the tendency of the motor vehicle wheels to lift off may be inferred from this contact force in accordance with the present invention. A contact force of a tire that is standing still can be determined from the tire deformation.

The preceding description of the exemplary embodiments according to the present invention is only for purposes of illustration and does not limit the scope of the present invention. Within the context of the present invention, different changes and modifications are possible without departing from the scope of the invention or its equivalents.

What is claimed is:

1. A system for monitoring the traction of a motor vehicle having at least two wheels (12), comprising:
at least one wheel-force sensor (10) assigned to a wheel (12) that detects at least one wheel-force component of the respective wheel (12) acting essentially between the road surface and tire contact surface, and that emits a signal (Si, Sa) representing the wheel-force component; and
an evaluation device (14) that processes the signal (Si, Sa) representing the wheel-force component of the wheel (12),
wherein the evaluation device (14) evaluates when the wheel (12) in question is lifting off according to the processing results.

2. The system as recited in claim 1,
wherein the evaluation device (14) compares the signal (Si, Sa) representing the wheel-force component to at least one predetermined wheel-force threshold value and evaluates when respective wheel (12) is lifting off according to the comparative results.

3. The system as recited in claim 1 or 2, wherein
at least two wheels (12) are each assigned to a sensor (10) of this type; and
the evaluation device (14) compares the signals (Si, Sa) representing the detected wheel-force components of at least two wheels (12) and evaluates when the wheels (12) are lifting off according to the comparative results.

4. The system as recited in one of the preceding claims,
wherein the sensor (10) is a wheel contact-force sensor (20, 22, 24, 26, 28, 30) that detects the wheel contact force.

5. The system as recited in one of the preceding claims,
wherein the sensor (10) is a lateral wheel force sensor (20, 22, 24, 26, 28, 30) that detects the lateral wheel force.

6. The system as recited in one of the preceding claims, wherein
it has a memory device (15) for storing a preceding sensor signal; and
the evaluation device (14) also determines a change over time of the detected wheel-force component by processing the preceding sensor signal and an active sensor signal, comparing the determined change to a predetermined change threshold, and then evaluating when at least one wheel is lifting off according to the comparative results.

7. The system as recited in one of the preceding claims, wherein
the evaluation device (14) emits an actuating signal according to the result of the evaluation; and
the system also includes an actuating device (16) that influences an operating state of the motor vehicle in accordance with the actuating signal.

8. The system as recited in one of the preceding claims,
wherein the actuating device (16) changes the engine output and/or the wheel braking pressure of at least one wheel (12) in accordance with the actuating signal of the evaluation device (14).

9. The system as recited in one of the preceding claims,
wherein the actuating device (16) increases the wheel braking pressure of at least one wheel on the outside of a curve.

10. The system as recited in one of the preceding claims,
wherein the sensor (10) is a tire sensor (20, 22, 24, 26, 28, 30).

11. The system as recited in one of the preceding claims,
wherein the sensor (10) is a wheel-bearing sensor.

12. The system as recited in one of the preceding claims,
wherein the actuating device (16), and possibly the evaluation device (14), is (are) assigned to a device for controlling and/or regulating the handling of a motor vehicle such as an ABS and/or TCS system.

13. A system for controlling and/or regulating the handling of a motor vehicle having at least one tire (32) and/or one wheel (12), a force sensor (20, 22) located in the tire (32) and/or on the wheel (12), especially on the wheel bearing, and a wheel variable that represents the tendency of the wheel (12) to lift off from the roadway and that is determined in dependence upon of the output signals of the force sensor, and this wheel variable is used for the control and/or regulation of the handling.

14. A method for monitoring the traction of a motor vehicle having at least two wheels, comprising the following steps:
detection (S01) of at least one wheel-force component acting essentially between the road surface and tire contact surface on at least one wheel; and
processing (S02, S03, S04, S05, S06, S07) of the detected wheel-force component,
wherein the processing step (S02, S03, S04, S05, S06, S07) includes an evaluation (S03, S04, S05, S06, S07) of the tendency of the relevant wheel to lift off in accordance with the detected wheel-force component.

15. The method as recited in claim 14,
wherein the processing step (S02, S03, S04, S05, S06, S07) includes a comparison (S03, S05) of the detected wheel-force component to at least one predetermined wheel-force threshold value.

16. The method as recited in claim 14 or 15, wherein
the detection step (S01) includes the detection of at least one wheel-force component for at least two wheels (12); and
the processing step includes a comparison of the detected wheel-force components of the at least two wheels (12).

17. The method as recited in one of claims 14 through 16,
wherein the wheel contact force of the wheel (12) in question is detected as the wheel-force component.

18. The method as recited in one of claims 14 through 17,
wherein the lateral wheel force of the wheel (12) in question is detected as the wheel-force component.

19. The method as recited in one of claims 14 through 18,
wherein the processing step includes a determination of a change over time of the detected wheel-force component and its comparison to a predetermined change threshold value.

20. The method as recited in one of claims 14 through 19,
wherein it further includes a step to influence an operating state of the motor vehicle according to the evaluation results.

21. The method as recited in one of claims 14 through 20,
wherein the influencing step includes an alteration of the engine output and/or the wheel braking pressure of at least one wheel (12).

22. The method as recited in one of claims 14 through 21,
wherein the influencing step includes an increase in a wheel braking pressure of at least one wheel on the outside of the curve.

23. The method as recited in one of claims 13 through 22,
wherein in an evaluation of the liftoff behavior of at least one wheel (12), the vehicle speed is taken into consideration.

24. The method as recited in one of claims 13 through 23,
wherein the operating state of the vehicle is influenced by an device for controlling and/or regulating the handling of a motor vehicle, such as an ABS system and/or a TCS system.
